(19) United States
(12) Patent Application Publication
(10) Pub. No.: US 2003/0096209 A1
(43) Pub. Date: May 22, 2003

(54) Orthodontic braces for specialized patients

(76) Inventors: Raymond Sugiyama, Los Alamitos, CA (US); Mauricio B. Gonzalez, Mexico City (MX)

Correspondence Address: Fulwider Patton Lee & Utecht, LLP, Suite 1550, 200 Oceangate, Long Beach, CA, 90802, US

(21) Appl. No.: 10/007,737

(22) Filed: Nov. 9, 2001

(51) Int. Cl. A61C 3/00

(52) U.S. Cl. 433/8; 433/24

(57) ABSTRACT

An orthodontic system for particular use with Latin/Hispanic patients for correcting maloccluded teeth to produce a normalized preferred alignment using a set of upper and lower brackets having a base portion and a bracket body constructed to receive and secure an archwire. The brackets are constructed using specific parameters including torque angle, angulation, and offset individualized for each tooth and further constructed with a base having a rear surface for attachment to the labial or buccal surface of the crown of individual teeth.

### BACKGROUND OF THE INVENTION

1. Field of the Invention

This invention relates to the field of orthodontic equipment for use in positioning and moving the teeth into a preferred alignment, and specifically to an orthodontic bracket system adapted for specialized patients, namely the Latin/Hispanic population.

2. Description of the Prior Art

The art of straightening one's teeth has been known for centuries. While the concept has not changed, the methods and apparatus used to straighten an individual's teeth have changed drastically. Recently orthodontists have desired and have made efforts to produce appliances such as brackets, archwires and other related components mounted to the patient's teeth, which require the minimum amount of orthodontic interference during treatment and which still effect a straight and pleasing appearance to the patient's teeth. The first attempts in designing orthodontic appliances resulted in a set of brackets having a central arch wire receiving slot aligned in a parallel relationship to one another such that the arch wire was placed in a jagged pattern when mounted on the brackets of a patient having misaligned teeth. Thus, in order to effect the straightening of the patient's teeth, the orthodontist was required to frequently adjust the arch wire to induce the proper forces on the brackets to move the patient's teeth to a desired position. This type of interference, which the orthodontist desires to be reduced, includes such manipulation as the manual bending and reshaping of the wire by the orthodontist during the straightening procedure. Oftentimes, the orthodontist must manipulate the placement of the archwire or other component in order to achieve the proper angulation of the tooth based on the inherent abnormalities or anomalies of that particular patient's teeth. However, such practice is not precise and may cause the orthodontists to over manipulate the tooth angulation, and such practice increases the length of time that the patient remains in braces while the orthodontist slowly and carefully manipulates the devices to achieve the desired results by fractional bending of the archwire. Either way, the end result is much more time consuming than desired by both the patient and orthodontist alike.

In response to these unsatisfactory appliances and methods, a new straight wire design was developed which incorporated a set of brackets having built in torque, angulation, and rotation such that the arch wire mounted thereto was essentially straight and the bracket configuration induced the desired forces on the arch wire to move the teeth into a desired position. Thus, less adjustment was required thereby increasing patient comfort.

The brackets known and used by orthodontists and which form the prior art, have been fashioned only after careful study of the dental anatomy of patients whose teeth have been determined, by orthodontists, to lie in the ideal position. Thereafter standardized brackets were formed using parameters configured from these ideal patients. Examples of these standardized brackets include the Roth system, the McLaughlin Bennett system, Straight Wire, Modified Straight Wire, and Alexander systems. However, it is well known by those familiar with this art, that the standardized parameters were calculated from and based off of Caucasian patients. Therefore, when an Orthodontist selects the bracket he or she will place on the patient's teeth he will do so by selecting those brackets which are designed to achieve an ideal finished position in accordance with certain preselected norms. This system of standardization is readily perceived in U.S. Pat. No. 3,660,900 to Andrews which teaches the practice of finishing the tooth in such a way so as to produce a particular angle of inclination at the tooth surface on the facial side of the tooth and using set norms for each respective tooth in the patient's mouth.

While such a method is effective for the Caucasian patient, other racial groups have completely different tooth morphology and therefore may not always fit within these standardized norms. When a patient does not fit within these norms, the amount of time required to alter the tooth position as well as the number of times the patient must visit his or her orthodontists will increase because there needs to be an increased level of manipulation of the orthodontic apparatus in order to achieve a result which is necessarily outside the “standardized norms” of the Caucasian patient. Additionally, the types of anatomical differences which occur among various ethnic groups such that what is pleasing in the Caucasian smile, may not be pleasing or even possible to achieve in a different racial group.

One attempt to correct for these differences was presented in U.S. Pat. No. 5 5,533,895 to Andreiko et al. which presented norms and orthodontic appliances for producing same for the Asian and Caucasian groups. However this method of selecting orthodontic devices does not take into consideration the different morphological shape of the entire tooth and is primarily concerned with achieving a specific angulation. Therefore, in the case of the Hispanic patient, whose tooth morphology, alignment and facial presentation is significantly different than that of the Caucasian, mere alteration in the angulation and torque of the brace is insufficient to take into account the variety of anatomical differences between their teeth and the Caucasian tooth.

Therefore, a need still exists whereby a orthodontic device is designed to take into consideration the different morphology of the Latin/Hispanic tooth including the statistically significant difference in the relative size of the Hispanic tooth, the variation of the bite lay, as well as the proper angulation and torque alterations which create a pleasing facial expression. At the same time, it is important to create a brace that accomplishes the goal of straight and pleasing teeth in a time efficient and cost effective manner.

### SUMMARY OF THE INVENTION

A system and apparatus to create a standardized orthodontic bracket and brace set for application to patients from a specific anatomical group, particularly the Latin and Hispanic anthropological group is provided herein. The brackets and brace sets of the present invention are provided having a shape and angulation designed specifically to achieve fast and convenient straightening of the teeth for individuals from the Latin and Hispanic racial group. By meticulously measuring and studying the morphological differences found in the Latin tooth and using these measurements to determine what the preferred angulation of the teeth and facial presentation, a new and unique set of statistical norms have been determined and a corresponding set of brackets have been designed to achieve the proper movement and angulations of the teeth in the shortest required time. This has been accomplished by building in a novel bracket orientation based on the different tooth morphology of the Latin/Hispanic tooth.

By use of the present invention, the orthodontist who has patients from the Latin/Hispanic racial group may quickly and effectively select the appropriate brace series corresponding to the teeth that need to be moved, and then attach only those braces to the patient's teeth. Because of the unique and specialized design of the braces of the present invention, the brace is predesigned to achieve the standardized norms for this racial group. The orthodontist will therefore be free from the need to continually interfere and experiment with what is the most effective and proper tooth angulation and there will no longer be a need to guess at how to achieve the desired results.

The preferred embodiment of the orthodontic device and system of the present invention is in the form of a series of specialized stainless steel brackets configured with a base having oppositely spaced tie wings on a bracket body projecting from the front side of the base and which are designed for receipt of an archwire and a ligature for securing the archwire to the bracket. Each base includes a back surface that is specially designed to fit a specific tooth on each side of the patient's mouth. The system is further comprised so that each bracket has a corresponding and oppositely placed bracket on the other side of the patient's mouth. Furthermore, each bracket has been designed to quickly and expeditiously achieve the desired tooth movement. The entire system facilitates fast and simplified orthodontic corrections.

### BRIEF DESCRIPTION OF THE DRAWINGS

FIG. 1 is a schematic view of an orthodontic system embodying the present invention as operating on an exemplary set of lower teeth;

FIG. 2. is a schematic view of the maxillary brackets for the left upper side quadrant, in enlarged scale, used in the orthodontic system illustrated in FIG. 1.

FIG. 3 is a schematic view of the mandibular brackets for the left lower side quadrant, in enlarged scale, used in the orthodontic system illustrated in FIG. 1; and

FIG. 4 is an distal end view, in enlarged scale, of an exemplary bracket illustrated in FIG. 1; and

FIG. 5 is a top view of the bracket illustrated in FIG. 4.

Other features and advantages of the invention will become apparent from the following detailed description, taken in conjunction with the accompanying drawings, which illustrate, by way of example, the features of the invention.

### DETAILED DESCRIPTION OF THE PREFERRED EMBODIMENT

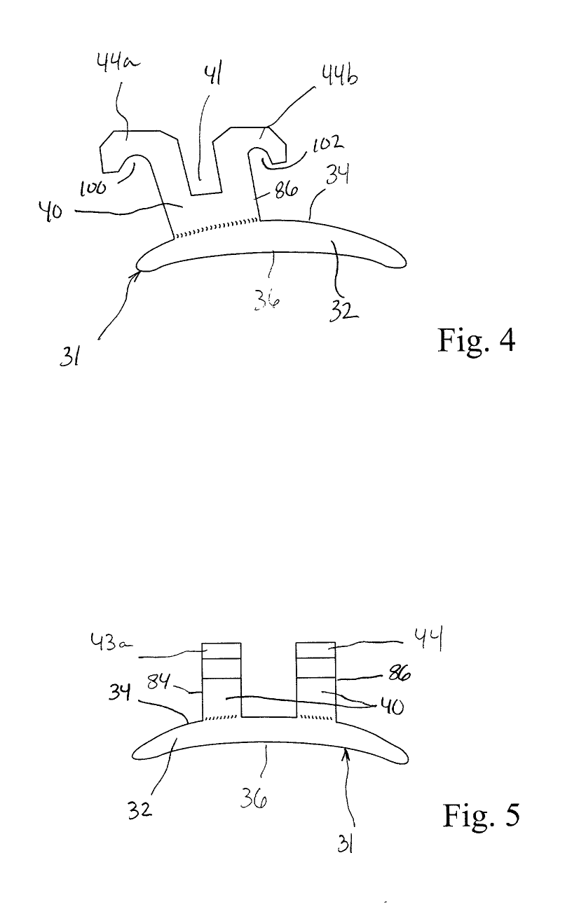

In general terms, the present invention is directed primarily to a set of orthodontic appliances with a built-in prescription to mount on maloccluded teeth and cooperate with an archwire and ligature material using conventional orthodontic techniques to move the teeth into a preferred alignment having an established norm for Latin and Hispanic patients. Any conventional appliance set having the general structure described herein may be modified to provide the prescription discussed herein. For purposes of this description, it will be assumed that an American appliance set such as that available from Ormco Corporation in Glendora, Calif. may be used and modified to provide the following prescription. In addition, the terms torque angle, angulation, and rotation and their associated orientations and reference points are all terms of art well known to one of ordinary skill in the art. Thus, only one exemplary bracket is illustrated in FIGS. 4-5 with the remaining brackets having similar features with the exception of the specific built-in orientation parameters as will be described below.

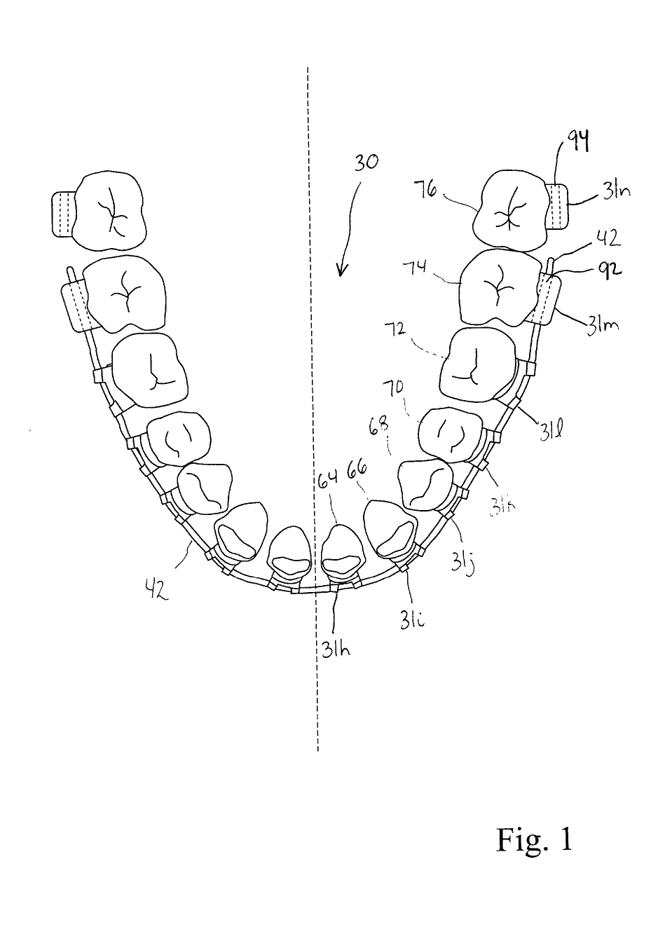

Referring now to FIGS. 1-5, an orthodontic system, generally designated 30, is provided for the optimization of tooth movement for persons of Hispanic or Latin descent. Such orthodontic system 30 generally includes a plurality of brackets 31a-n having a base portion 32a-n with a front 34 and a back surface 36 being adapted to be bonded to the labial or buccal surface of the teeth using any suitable material. The base is generally formed to generally correspond to the curvature of the labial or buccal surface of the crown of individual teeth. Extending outwardly from each base is a bracket body 40 for receiving a section of an archwire 42. For the non-molar brackets, such bracket body includes a mesial tie wing 43 and a distal tie wing 44 for retaining a ligating module (not shown) which secures the archwire 42 to the bracket body 40. For the molar brackets the bracket bodies are in the form of a buccal tube 82, 88, 92, 94 for receipt of the free end of the archwire 42. Selected ones of the brackets 31a-n are positioned on the teeth to cooperate with the archwire to move the maloccluded teeth into a proper position over time with periodic adjustments. Advantageously, the brackets 31 are designed to provide a set of built-in torque angles, angulations, and rotation angles to minimize the relative degree of adjustment for Latin/Hispanic patients to attain a preferred normalized alignment. This combination of torque angles, angulation, and rotation angles forms a prescription for the orthodontic treatment of Latin/Hispanic patients based on a set of established norms derived for untreated teeth having the desired alignment.

In general terms, the mouth can generally be divided into four quadrants including the upper left side, the upper right side, the lower left side and the lower right side. It will be understood that the right half and left half brackets are mirror images of one another when mounted on their respective tooth surfaces and thus only the brackets for the left side of the mouth will be described.

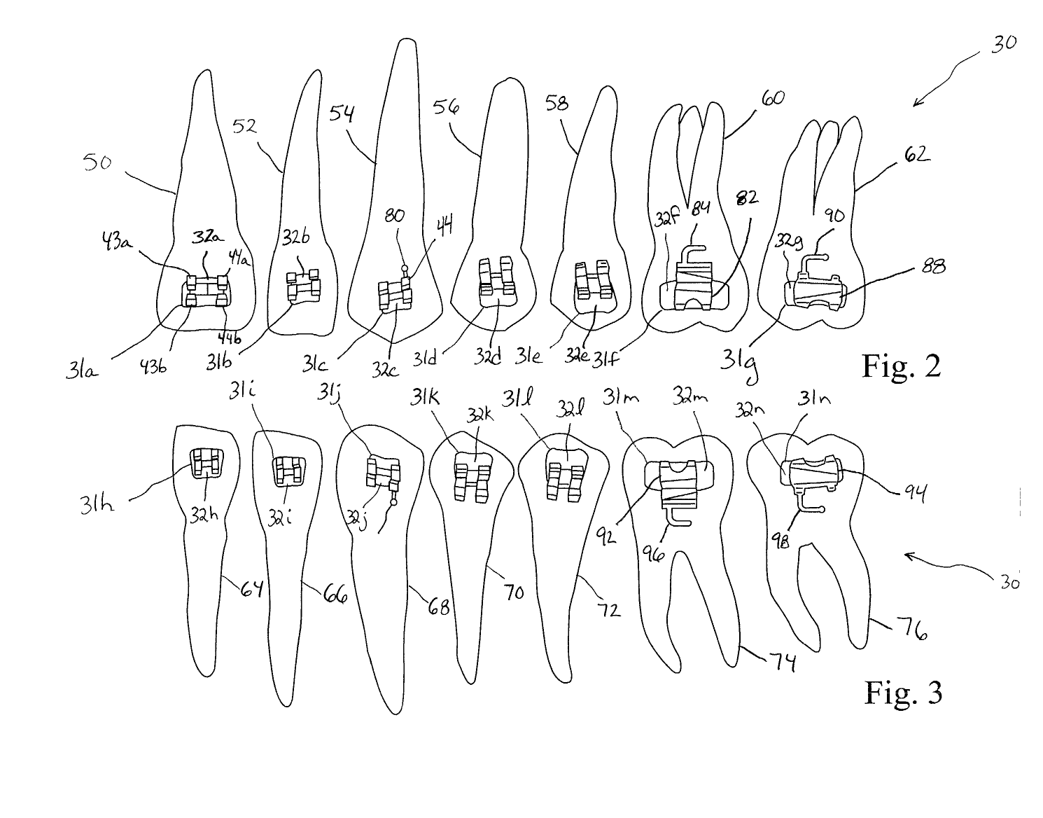

Referring now to FIGS. 2 and 3, a typical set of upper and lower left side teeth are illustrated including the brackets positioned thereon. The left side set of upper teeth include an upper central 50, an upper lateral 52, an upper cuspid 54, an upper first bicuspid 56, an upper second bicuspid 58, an upper first molar 60, and an upper second molar 62. The left side lower teeth include a lower central 64, a lower lateral 66, a lower cuspid 68, a lower first bicuspid 70, a lower second bicuspid 72, a lower first molar 74, and a lower second molar 76. Each tooth receives a bracket bonded by a suitable material to the labial or buccal side of its crown and centrally positioned using conventional orthodontic techniques.

With continued reference to FIG. 2, the upper left central bracket 31a includes an elongated base 32a having a generally rectangular profile with a gingival edge having a concave curvature relative to the bracket 31a, a straight lower edge, and mesial and distal edges also having a concave contour relative to the bracket. It will be understood that the gingival edge is the edge of the bracket, when installed, closest to the gum line. All with all the bracket bases, the edges are rounded at their respective points of convergence. With continued reference to FIG. 2 along with the exemplary bracket illustration in FIGS. 4-5, the bracket 31a itself includes a mesial stem 84 and a distal stem 86 supporting the respective mesial and distal tie wings 43 and 44. Each tie wing includes central transversely projecting archwire guide slots 41 separating upper and lower retention hooks 43a, 43b, 44a, and 44b for receipt of an archwire 42 and are formed to position the archwire along a preferred line to maximize the correction of tooth orientation to a preferred alignment. The tie wings enable the archwire to be ligated to the bracket structure with ligature wire, a ligating module (not shown), ligature elastics or other suitable means of ligation. The tie wings 43 and 44 are in parallel alignment to one another. This general structural arrangement applies to all non-molar brackets.

Referring again to FIG. 2, the upper left lateral bracket 31b includes a base 32b generally in the form of a rectangle including straight lower, mesial, and distal edges and a curved gingival edge that is concave in relation to the bracket body 40b. The base 32c of the upper left cuspid bracket 31c is similar in construction to the base 31b of the upper left lateral bracket. A ligature anchor 80 including a stem portion terminating in a rounded knob projects in a gingival direction from the distal tie wing 44. The upper first bicuspid bracket 31d and upper second bicuspid bracket 31e include respective bases 32d and 32e having a similar construction to the base 32b for the upper left bracket 31b except for being slightly larger in scale. The tie wings 43, 44 of the first and second bicuspid brackets are also slightly larger than the tie wings of the left upper central, lateral, and cuspid brackets.

As further depicted in FIG. 2 the upper first molar 31f includes a generally elongated rectangular shaped base 32f with straight lower, mesial, and distal edges and a slightly contoured gingival edge. A buccal tube 82 extends outwardly from the base and is conventionally constructed with a hollow bore to receive and anchor a free end to the archwire 42. Extending in a gingival direction from the mesial end of the buccal tube 86 and then turning distally is an integrated ball hook 84 for anchoring one end of an elastic ligature and cooperating with the ligature anchor 80 on the upper left cuspid bracket 31c to move the teeth when the brackets are installed.

The upper second molar 31g is formed with a base 32g that is constructed similarly to the base 32f of the upper first molar 31f. A second buccal tube 88 is hollow for receipt of a free end of the archwire 42 to secure the archwire 42 as is known to one of ordinary skill in the art. A second integrated ball hook 90 is constructed and located in a manner similar to the first ball hook 84 on the upper first molar 31f.

Referring now to FIG. 3, brackets 31h-31n are adapted to be attached to individual lower teeth. The lower central bracket 31h is formed with a base 32h in the form of a trapezoid with a straight gingival edge. Flaring outwardly from the gingival edge are a pair of straight mesial and distal edges which both adjoin a straight top edge. The base 32i of the lower left lateral bracket 31i is shaped similarly to the base 32h of the lower left central bracket 31h.

Still referring to FIG. 3, the respective bases 32j-32n of the lower left cuspid, first bicuspid, second bicuspid, first molar and second molar bracket 31j-31n are substantially mirror images of their left upper counterpart bases 32c-32g. The lower left molars also including buccal tubes 92, 94 and first and second integrated ball hooks 96, 98 constructed in a similar fashion.

When the brackets 31a-31e and 31h-31l are mounted on their respective teeth, the hooks 43a, 43b, 44a, 44b project buccally or labially (outwardly from the outermost surface of the tooth). The upper hooks 43a, 43b project upwardly away from the archwire guide slots 41a, 41b and then inwardly toward the base 32 and cooperate to form an upper recess 100 (FIG. 4). The lower hooks 44a, 44b project downwardly away from the archwire guide slots 41a, 41b to turn inwardly toward the base 32 and cooperate to form a lower recess 102. A conventional ligating module (not shown) may be inserted over the hooks and retained within the recesses 100 and 102 by the set of four hooks 43a,43b, 44a, and 44b to secure the archwire to the respective bracket.

In order to minimize the adjustments needed to attain a preferred alignment in Latin/Hispanic patents it has been found that the following that the following bracket dimensional and orientation parameters provide a preferred orthodontic system to correct maloccluded teeth. Measurements of the torque angle, degree of angulation, and rotation are well known to those ordinary skill in the art. In general terms, the torque angle provides a measurement for aligning a tooth from the buccal or labial side of the mouth to the lingual side. The degree of angulation provides a measurement for aligning a tooth between the anterior portion of the mouth to the posterior area of the mouth. Rotation angle is measured about the preferred central axis of each tooth. Each of these terms is well defined in the art.

More specifically, the parameters of each bracket 31a-n in the orthodontic system 30 designed for a patient of Latin/Hispanic descent to established a normalized position is preferably as follows:

TABLE 1
Maxillary bracket prescription (+/− 1.0 degrees)

| Tooth/Bracket | Torque | Angulation | Rotation |
|---|---|---|---|
| Central (31a) | +24 | +3 | 0 |
| Lateral (32a) | +18 | +6 | 0 |
| Cuspid (33a) | +8 | +9 | −5 mesial |
| First Bicuspid (34a) | −6 | 0 | 0 |
| Second Bicuspid | −6 | 0 | 0 |
| (35a) | | | |
| First Molar (36a) | −8 | +5 | +14 distal |
| Second Molar (37a) | −8 | 0 | +12 distal |

TABLE 2
Mandibular Bracket prescription (+/− 1.0 degrees)

| Tooth/Bracket | Torque | Angulation | Rotation |
|---|---|---|---|
| Central (38a) | +3 | 0 | 0 |
| Lateral (39a) | +3 | 0 | 0 |
| Cuspid (40a) | −5 | +5 | −5 mesial |
| First Bicuspid (41a) | −12 | +2 | 0 |
| Second Biscuspid | −17 | +2 | 0 |
| (42a) | | | |
| First Molar (42a) | −25 | +4 | +8 distal |
| Second Molar (43a) | −25 | 0 | +8 distal |

These parameters provide a prescription for a set of orthodontic appliances for providing a preferable treatment for those of Latin/Hispanic origins. The slot size 41 or buccal tube 106, 107, 135, 136 inner diameter for each bracket 31a-31n is selected to be 0.018×0.025 inches or 0.022×0.025 inches depending on the diameter of the anchor wire 42 to be used. Other suitable dimensions may be selected. The base may be formed integrally with the bracket body or may be connected in any suitable manner such welding, bonding, and the like.

Using conventional orthodontic techniques, the orthodontist selects the desired set of brackets to realign any maloccluded teeth and mounts the selected brackets on their respective teeth using a suitable bonding material. The archwire is then inserted through the archwire slots of each of the brackets and anchored to a molar bracket. Ligatures are placed over the respective tie wings of each bracket to secure the archwire thereto. The built-in orientation parameters of each of the brackets cooperate to ensure the structure of the bracket will exert the proper forces on the associated tooth and move the tooth into a preferred position which is an established norm for a Latin or Hispanic patient. The brackets configured with their respective built-in orientation parameters drive the affected teeth from the maloccluded position to the preferred position using a minimum amount of adjustment and once the preferred alignment is established no further adjustments are necessary as the alignment established is the norm for the morphology of the Latin or Hispanic patient. Thus, less time is required to align the teeth in a preferred position adding to the comfort level of the patient.

Thus, it will be appreciated that by bonding the brackets described herein to their corresponding upper or lower tooth and attaching the archwire 42 and ligatures (not shown), the orthodontic system 30 may be adjusted periodically using conventional orthodontic techniques such that a preferred alignment may be attained using minimal adjustments both maximizing the patient's comfort and reducing the orthodontists time.

While the present invention has been described herein in terms of a preferred prescription for establishing a normalized alignment in Latin or Hispanic patients, various changes and improvements may also be made to the invention without departing from the scope thereof.

What is claimed is:

1. An orthodontic system designed for optimal movement of the teeth of a Hispanic or Latin patient, said system including:
a plurality of brackets having a base portion including a front surface and a back surface, said back surface being adapted for attachment to a tooth;
a bracket body projecting outwardly from said front surface each respective said bracket and including opposing mesial and distal tie wings constructed for receipt of an archwire and a ligature; and
each of said brackets being configured with a set of built-in orientation parameters including a torque angle, an angulation angle, and a rotation angle acting in combination and cooperating with said archwire, when installed, to move and straighten the teeth from a maloccluded position to a position of an established norm for a Hispanic or Latin patient using relatively few adjustments.

2. An orthodontic system according to claim 1 wherein:
at least one of said brackets is constructed with a rotation of 0 degrees, an angulation of positive 3 degrees, and a torque angle of positive 24 degrees for attachment to an upper central tooth.

3. An orthodontic system according to claim 1 wherein:
at least one of said brackets is constructed with a rotation of 0 degrees, an angulation of positive 6 degrees, and a torque angle of positive 18 degrees for attachment to an upper lateral tooth.

4. An orthodontic system according to claim 1 wherein:
at least one of said brackets is constructed with a rotation of minus 5 degrees in a mesial direction, an angulation of positive 9 degrees, and a torque angle of positive 8 degrees for attachment to an upper cuspid tooth.

5. An orthodontic system according to claim 1 wherein:
at least one of said brackets is constructed with a rotation of 0 degrees, an angulation of 0 degrees, and a torque angle of minus 6 degrees for attachment to an upper first or upper second bicuspid tooth.

6. An orthodontic system according to claim 1 wherein:
at least one of said brackets including a buccal tube for receipt of a free end of said archwire and constructed with a rotation of positive 14 degrees in a distal direction, an angulation of positive 5 degrees, and a torque angle of minus 8 degrees for attachment to an upper first molar tooth.

7. An orthodontic system according to claim 1 wherein:
at least one of said brackets including a buccal tube for receipt of a free end of said archwire and constructed with a rotation of positive 12 degrees in a distal direction, an angulation of 0 degrees, and a torque angle of minus 8 degrees for attachment to an upper second molar tooth.

8. An orthodontic system according to claim 1 wherein:
at least one of said brackets is constructed with a rotation of 0 degrees, an angulation of 0 degrees, and a torque angle of positive 3 degrees for attachment to a lower central or lower lateral tooth.

9. An orthodontic system according to claim 1 wherein:
at least one of said brackets is constructed with a rotation of minus 5 degrees in a mesial direction, an angulation of positive 5 degrees, and a torque angle of minus 5 degrees for attachment to a lower cuspid tooth.

10. An orthodontic system according to claim 1 wherein:
at least one of said brackets is constructed with a rotation of 0 degrees, an angulation of positive 2 degrees, and a torque angle of minus 12 degrees for attachment to a lower first bicuspid tooth.

11. An orthodontic system according to claim 1 wherein:
at least one of said brackets is constructed with a rotation of 0 degrees, an angulation of positive 2 degrees, and a torque angle of minus 17 degrees for attachment to a lower second bicuspid tooth.

12. An orthodontic system according to claim 1 wherein:
at least one of said brackets including a buccal tube for receipt of a free end of said archwire and constructed with a rotation of positive 8 degrees in a distal direction, an angulation of positive 4 degrees, and a torque angle of minus 25 degrees for attachment to a lower first molar tooth.

13. An orthodontic system according to claim 1 wherein:
at least one of said brackets includes a buccal tube for receipt of a free end of said archwire and constructed with a rotation of positive 8 degrees in a distal direction, an angulation of 0 degrees, and a torque angle of minus 25 degrees for attachment to a lower second molar tooth.

14. A set of orthodontic brackets for Latin/Hispanic patients comprising:
a plurality of upper brackets and a plurality of lower brackets, said upper brackets and lower brackets including a left-half subset and a right-half subset being a mirror image of one another, each of said subsets including a cental bracket, a lateral bracket, a cuspid bracket, a first bicuspid bracket, and a second bicuspid bracket;
each of said brackets including a base having a bracket body with a stem having a mesial tie wing and distal tie wing at opposing ends of said stem for securing a ligature, said brackets further including an archwire guide slot for receipt of an archwire and being constructed with orientation parameters including a torque angle, an angulation angle, and an offset angle;
wherein the parameters for each bracket include:
for the upper central brackets:

| | |
|---|---|
| Torque angle: | +24 degrees, |
| Angulation: | +3 degrees, |
| Rotation: | 0 degrees, |

for the upper lateral brackets:

| | |
|---|---|
| Torque angle: | +18 degrees, |
| Angulation: | +6 degrees, |
| Rotation: | 0 degrees, |

for the upper cuspid brackets:

| | |
|---|---|
| Torque angle: | +8 degrees, |
| Angulation: | +9 degrees, |
| Rotation: | −5 degrees distal, |

for the upper first and second bicuspid brackets:

| | |
|---|---|
| Torque angle: | −6 degrees, |
| Angulation: | 0 degrees, |
| Rotation | 0 degrees, |

for the lower central and lateral brackets:

| | |
|---|---|
| Torque angle: | +3 degrees, |
| Angulation: | 0 degrees, |
| Rotation | 0 degrees, |

for the lower cuspid brackets:

| | |
|---|---|
| Torque angle: | −5 degrees, |
| Angulation: | −5 degrees, |
| Rotation | −5 degrees mesial, |

for the lower first bicuspid brackets:

| | |
|---|---|
| Torque angle: | −12 degrees, |
| Angulation: | +2 degrees, |
| Rotation | 0 degrees, |

for the lower second bicuspid brackets:

| | |
|---|---|
| Torque angle: | −17 degrees, |
| Angulation: | +2 degrees, |
| Rotation | 0 degrees; and |

wherein the parameters for each bracket are approximately
within +/− 1.0 degree.

15. The set of orthodontic brackets as set forth in claim 14 further including:
a lower first molar bracket;
a first upper molar bracket;
a second lower molar bracket;
a second upper molar bracket;
each of said molar brackets including a buccal tube projecting outwardly from a base for securing a free end of said archwire, said base and tube being constructed in accordance with orientational parameters including a torque angle, an angulation angle, and an offset angle;
wherein the parameters for each said molar bracket include:
for the upper first molar bracket:

| | |
|---|---|
| Torque angle: | −8 degrees, |
| Angulation: | +5 degrees, |
| Rotation: | +14 degrees distal, |

for the upper second molar bracket:

| | |
|---|---|
| Torque angle: | −8 degrees, |
| Angulation: | 0 degrees, |
| Rotation: | +12 degrees distal, |

for the lower first molar bracket:

| | |
|---|---|
| Torque angle: | −25 degrees, |
| Angulation: | −4 degrees, |
| Rotation: | +8 degrees distal, |

for the lower second molar bracket:

| | |
|---|---|
| Torque angle: | −25 degrees, |
| Angulation: | 0 degrees, |
| Rotation: | +8 degrees distal; and |

wherein the parameters for each molar bracket are approximately
within +/− 1.0 degree.

16. A set of orthodontic brackets for Latin/Hispanic patients comprising:
a plurality of upper brackets including a left-half subset and a right-half subset being a mirror image of one another, each of said subsets including a cental bracket, a lateral bracket, a cuspid bracket, a first bicuspid bracket, and a second bicuspid bracket;
each of said brackets including a base having a bracket body with a bridge having a mesial tie wing and distal tie wing at opposing ends of said bridge for securing a ligature, said brackets further including an archwire guide slot for receipt of and archwire and being constructed with orientation parameters including a torque angle, an angulation angle, and an offset angle;
wherein the parameters for each bracket include:
for the upper central brackets:

| | |
|---|---|
| Torque angle: | +24 degrees, |
| Angulation: | +3 degrees, |
| Rotation: | 0 degrees, |

for the upper lateral brackets:

| | |
|---|---|
| Torque angle: | +18 degrees, |
| Angulation: | +6 degrees, |
| Rotation: | 0 degrees, |

for the upper cuspid brackets:

| | |
|---|---|
| Torque angle: | +8 degrees, |
| Angulation: | +9 degrees, |
| Rotation: | −5 degrees distal, |

for the upper first and second bicuspid brackets:

| | |
|---|---|
| Torque angle: | −6 degrees, |
| Angulation: | 0 degrees, |
| Rotation | 0 degrees; and |

wherein the parameters for each bracket are approximately
within +/− 1.0 degree.

17. A set of orthodontic brackets for Latin/Hispanic patients comprising:
a plurality of lower brackets including a left-half subset and a right-half subset being a mirror image of one another, each of said subsets including a cental bracket, a lateral bracket, a cuspid bracket, a first bicuspid bracket, and a second bicuspid bracket;
each of said brackets including a base having a bracket body with a bridge having a mesial tie wing and distal tie wing at opposing ends of said bridge for securing a ligature, said brackets further including an archwire guide slot for receipt of and archwire and being constructed with orientation parameters including a torque angle, an angulation angle, and an offset angle;
wherein the parameters for each bracket include:
for the lower central and lateral brackets:

| | |
|---|---|
| Torque angle: | +3 degrees, |
| Angulation: | 0 degrees, |
| Rotation | 0 degrees, |

for the lower cuspid brackets:

| | |
|---|---|
| Torque angle: | −5 degrees, |
| Angulation: | +5 degrees, |
| Rotation | −5 degrees mesial |

for the lower first bicuspid brackets:

| | |
|---|---|
| Torque angle: | −12 degrees, |
| Angulation: | +2 degrees, |
| Rotation | 0 degrees, |

for the lower second bicuspid brackets:

| | |
|---|---|
| Torque angle: | −17 degrees, |
| Angulation: | +2 degrees, |
| Rotation | 0 degrees; and |

wherein the parameters for each bracket are approximately
within +/− 1.0 degree.
